(19) United States
(12) Patent Application Publication
(10) Pub. No.: US 2009/0177862 A1
(43) Pub. Date: Jul. 9, 2009

(54) Input device for executing an instruction code and method and interface for generating the instruction code

(76) Inventor: Kuo-Shu Cheng, Hsin-Tien City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,065

(22) Filed: Jan. 7, 2008

(51) Int. Cl. G06F 15/76

(52) U.S. Cl. 712/24; 712/E09.016

(57) ABSTRACT

An input device for executing an instruction code and method and interface for generating the instruction code are disclosed. The method for generating an instruction code which is executed by an input device includes the steps of: opening a specific purpose programming interface which is used for simulating to show a plurality of corresponding buttons according the input device; selecting a corresponding button waiting for being defined and entering a programming window; selecting any instruction for the corresponding button waiting for being defined to form a combined operation instruction in proper sequence; compiling the combined operation instruction to form an instruction code which can be executed by the input device; and downloading the instruction code to the input device. Accordingly, the input device can show a continuous operation action when the corresponding button waiting for being defined is pressed.

### BACKGROUND OF THE INVENTION

1. Field of the Invention

The present invention relates to an input device, especially to an input device for executing an instruction code and method and interface for generating the instruction code.

2. Description of Related Art

In computer systems, common input devices include mice, keyboards, writing pads and so on, wherein most of conventional mice only have several operation buttons such as a left button, a right button and a wheel, so users always need to operate on a mouse and a keyboard at the same time when applying complicated application software (for example, game software and drawing software etc.).

For example in game software it is assumed that during a computer game, a character in the game crouches down only when a user simultaneously respectively presses a button on a mouse and a control button “Ctrl” on a keyboard with his two hands, and the character stands up after the user releases the button on the mouse. So, the user must frequently and simultaneously operate on the mouse and the keyboard with his two hands during playing the game.

The above problem exists because defined buttons for software operation actions only are distributed on each single button of a mouse or a keyboard and there isn't a function of continuous action program between the buttons. In other words, conventional firmware programs for a mouse or a keyboard are too easy, so that the mouse or the keyboard cannot support continuous run of a plurality of single actions, and further, there isn't a related actual editor program corresponding to continuous run of the actions of the mouse or the keyboard to achieve a function of continuous operation actions for a single button.

A Chinese Patent Publication No. CN101059728A discloses a system and method for recording/refashioning operation data of a keyboard and a mouse. However, the system needs to be coupled with a keyboard, a mouse and at least one computer in addition, so that the number of accessories for the system increases, which causes complicated electrical installation and inconvenience in use. Furthermore, the patent application doesn't disclose how to achieve continuous actions of the keyboard or the mouse.

Hence, there is a need for improving a single input device so that all kinds of continuous actions can be performed on the single input device and users can easily edit and operate the single input device.

### SUMMARY OF THE INVENTION

An object of the present invention is to provide an input device for executing an instruction code and method and interface for generating the instruction code, which can edit and convert a continuous program to form an instruction code which can be executed by the input device so that a single button of a single input device can perform all kinds of continuous operation actions.

To achieve the above-mentioned object, a method for generating an instruction code which is executed by an input device in accordance with the present invention is provided. The method includes the steps of: opening a specific purpose programming interface which is used for simulating to show a plurality of corresponding buttons according the input device; selecting a corresponding button waiting for being defined and entering a programming window; selecting any instruction for the corresponding button waiting for being defined to form a combined operation instruction in proper sequence; compiling the combined operation instruction to form an instruction code which can be executed by the input device; and downloading the instruction code to the input device, thereby the input device shows a continuous operation action when the corresponding button waiting for being defined is pressed.

The present invention further provides an interface for generating an instruction code which is executed by the input device. The interface includes an appearance simulation area for simulating to show a plurality of corresponding buttons according to the input device; a button function selection area having a plurality of functions corresponding to each corresponding button; a programming window which provides selection instructions for each corresponding button to form a combined operation instruction in proper sequence; and a program download area which compiles the combined operation instruction to form an instruction code which can be executed by the input device and provides the instruction code for the input device to download, thereby the input device shows a continuous operation action when an corresponding button waiting for being defined is pressed.

The present invention further provides an input device for executing an instruction code which is connected to a computer system. The input device includes a plurality of button which are set to show continuous operation actions in the computer system; a non-volatile memory for storing a plurality of instruction codes downloaded from the computer system, which can be executed by the input device, wherein each instruction code corresponds to the continuous operation action of each button; and a microprocessor for receiving start signals of each button and correspondingly encoding and executing the instruction codes stored in the non-volatile memory according to the start signals.

To further understand methods, means and efficacy of the present invention, please refer to the above summary and the following detailed description and drawings related the present invention. Other objects and advantages of the present invention will be explained in the following description and drawings.

### BRIEF DESCRIPTION OF THE DRAWINGS

FIG. 1 and FIG. 2 are schematic views of an interface for generating an instruction code which is executed by an input device according to the present invention;

FIG. 3 is a flow chart of a method for generating an instruction code which is executed by an input device according to the present invention; and

FIG. 4 is a block schematic view of the input device for executing an instruction code according to the present invention.

### DETAILED DESCRIPTION OF THE PREFERRED EMBODIMENTS

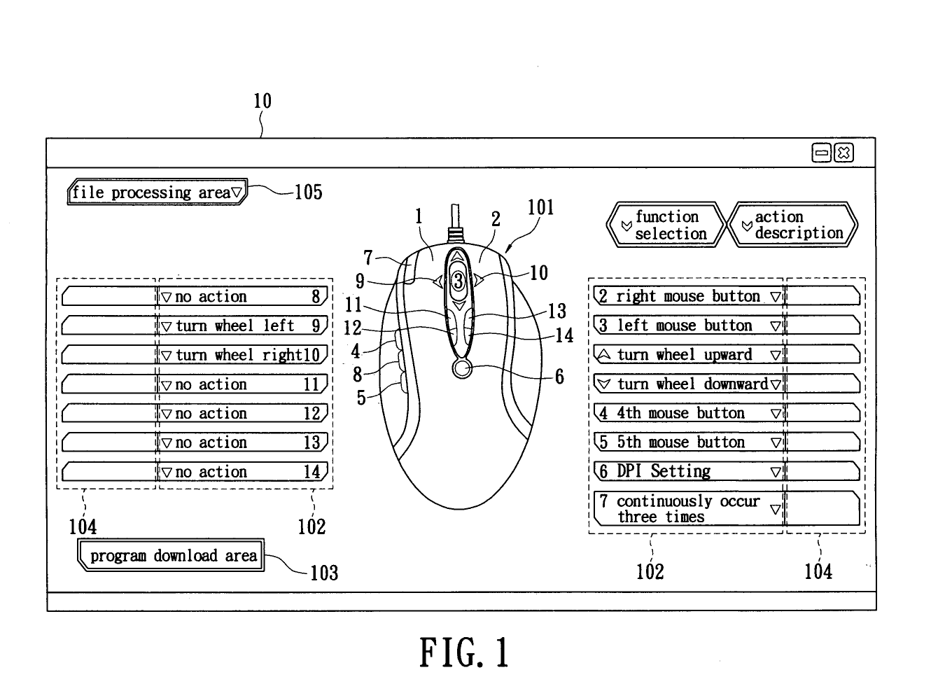

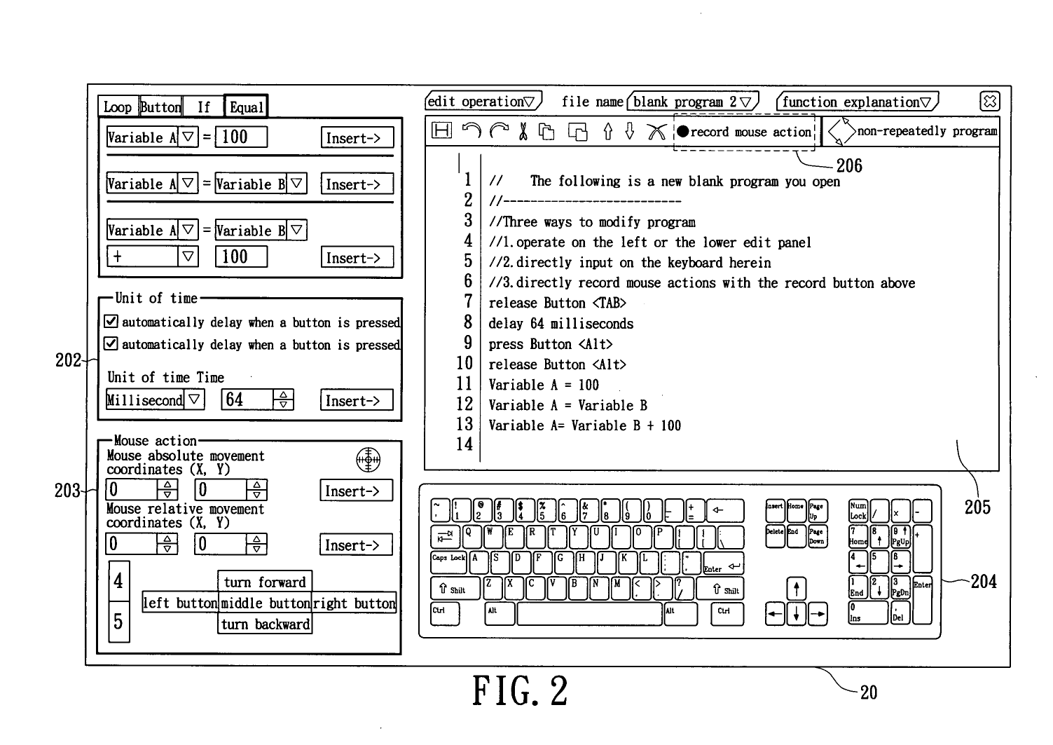

Please refer to FIG. 1 and FIG. 2 illustrating an interface for generating an instruction code which is executed by an input device according to the present invention, wherein FIG. 1 illustrates a specific purpose programming interface 10 of the interface for generating an instruction code, which includes an appearance simulation area 101, a button function selection area 102 and a program download area 103, and FIG. 2 illustrates a programming window 20 of the interface for generating an instruction code.

The appearance simulation area 101 is used for simulating to show a plurality of corresponding buttons (for example, Numbers 1-14, upward arrowheads and downward arrowheads in FIG. 1) corresponding to a plurality of buttons on the input device (for example, a mouse). Though this embodiment takes a mouse as an example of the input device to illustrate, the present invention isn't limited in the scope and also may be adapted for other input devices such as common keyboards. So the corresponding buttons simulated and shown in different appearance simulation areas may correspond to all buttons and wheels on different input devices.

The button function selection area 102 has a plurality of functions corresponding to each corresponding button described above. The functions includes event selections corresponding to keyboards, mice, multimedia, networks, systems, inputting characters, executing software, entering program and executing programming files. For example, if users need to redefine a button originally numbered 2, then they may pull down the menu to select one of the functions.

When users pull down the menu to select “keyboard”, a virtual keyboard will appear on the interface 10 for the users to select actions which are desired to be executed by a button waiting for being defined. For example, the users can define the button numbered 2 to execute actions corresponding to a button “enter” on the keyboard. Accordingly, users can select any button waiting for being defined to execute the following actions:

“mouse” functions: no action, left mouse button, right mouse button, middle mouse button, the fourth mouse button, the fifth mouse button, turn wheel upward, turn wheel downward, turn wheel left, turn wheel right;

“multimedia” functions: Rew, Dew, stop, play/pause, mute, increase volume, decrease volume;

“network” functions: page up, page down, stop, refresh, search, my favorite, explorer, E-mail;

“system” functions: turn on calculator, turn on my computer, computer standby, turn off computer;

“input character” function: create a dialogue box for users to input a paragraph via input buttons on an actual keyboard;

“execute software” function: create a dialogue box for users to select an application from a catalog, wherein the application in the catalog may be executed basing on a system call function during operation; and

“execute programming files” function: provide program instructions which have been programmed in the programming window 20 for users to select.

Of course, if users want to self-select more complicated continuous actions, they may select the “enter program” function to enter the programming window 20. The programming window 20 provides any selection instruction for each corresponding button to form a combined operation instruction in proper sequence. The program used in the present invention is an instruction program similar to human language, which includes:

a plurality of operator instructions:

(1) “loop” instruction: instruction for executing repeatedly during an interval, which is edit and put in a programming area;

(2) “if” instruction: a conditional instruction, that is, if a condition holds, then jump to a designated line to execute program, which is put in the programming area, the instruction corresponding to a reduced conditional jump instruction;

(3) “equal” functions: variable data transit, arithmetic operation of variable data, logical operation of variable data, which are put in the programming area, the instruction corresponding to a reduced data transit instruction, logical operation instruction and arithmetic operation instruction; and

(4) “button” instruction: a conditional instruction, that is, if a button condition holds, then jump to a designated line to execute program, which is put in the programming area, the instruction corresponding to a conditional jump instruction. For example, if Button 2 is in a “pressed” state, then jump to the fifth line.

Furthermore, the selection instructions still include a time control instruction 202, a mouse simulating action instruction 203 and a keyboard simulating action instruction 204, wherein:

Time control instruction 202: to set time which is a basic factor for all actions, for example, time for pressing a button, waiting for a while and then pressing another button, etc. Units of time may be millisecond, second, minute and so on.

Mouse simulating action instruction 203: enable users to easily edit virtual mouse action which is put in the program area, wherein editing virtual mouse action may be setting absolute movement coordinates and relative movement coordinates of the mouse.

Keyboard simulating action instruction 204: to enable users to easily edit keyboard actions which are put in the program area.

The programming window 20 further provides a plurality of input operation instructions, such as variable values, time setting values, moving coordinate values and so on, and a programming area 205 which is provided for users to edit and shows edited content.

Besides virtual selection instructions described above, the programming window 20 further provides an actual keyboard action instruction and an actual mouse action record instruction 206. The actual keyboard action instruction enables users to directly input instructions via actual keyboards. For example, when users press Button D, the programming window 20 will automatically show four lines of programs in the programming area 205, of which the first line is pressing Button D, the second line is delaying 64 milliseconds (that is, a set time setting value in the time control instruction), the third line is releasing Button D, and the fourth line is delaying 64 milliseconds. The actual mouse action record instruction 206 instructs to press a record button to record coordinates and movements of any mouse and then show corresponding programs in the programming area 205.

The program download area 103 of the specific purpose programming interface 10 will compile the combined operation instruction edited and stored in the programming area 205 to form an instruction code which can be executed by the input device, and provide the instruction code for the input device to download, so that the input device may show a continuous operation action when the corresponding button waiting for being defined is pressed. The instruction code which can be executed by the input device is a code similar to Reduced Instruction Set Computer (RISC) code.

Additionally, the specific purpose programming interface 10 further includes an action description area 104 for annotating the continuous operation action corresponding to each corresponding button, for example, a button corresponding to Number 7. “Continuously occur three times” is described as “continuously click left mouse button three times”. The specific purpose programming interface 10 further includes a file processing area 105 which includes opening a new file, opening an old file, quickly opening a file, saving a file, saving as a new file, deleting a file, renaming a file, inserting a file, extracting a file, reading a file, downloading a file, ending a file. Users may pull down the menu to select one processing mode.

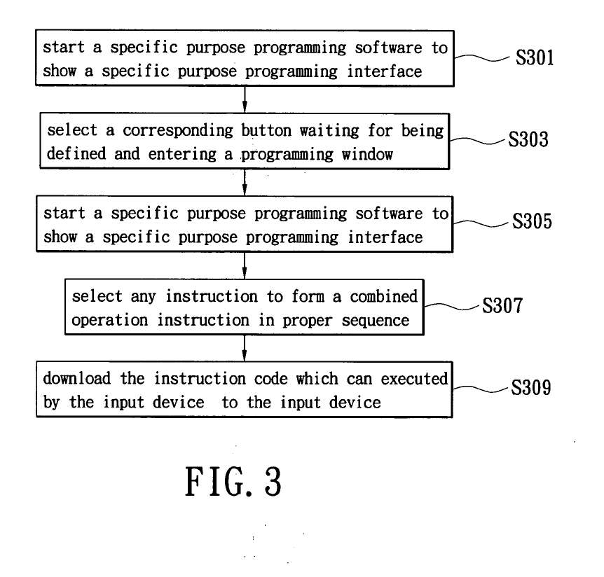

Please refer to FIG. 3 showing a flow chart of a method for generating an instruction code which is executed by the input device according to the present invention. The method includes the steps of: at step S301, starting a specific purpose programming software to show a specific purpose programming interface (that is, the interface for generating an instruction code described above) which is used for simulating to show a plurality of corresponding buttons corresponding to a plurality of buttons on the input device (the buttons include Buttons 1-14 as shown in FIG. 1); secondly, at step S303, selecting a corresponding button waiting for being defined and entering a programming window 20; at step S305, selecting any instruction for the corresponding button waiting for being defined to form a combined operation instruction in proper sequence; finally, at step S307, directly compiling the edited combined operation instruction to form an instruction code which can be executed by the input device if users select a button in a program download area 103, and at step S309, directly downloading the instruction code to the input device, thereby the input device shows a continuous operation action when the corresponding button waiting for being defined is pressed.

Please refer to the following example for further understanding the process for generating instruction code.

Example: Provide Button 8 with a function of three continuous actions of left mouse button.

Instructions are programmed as follows, wherein the left-most numbers are line numbers of the program:

7 press left button

8 delay 64 milliseconds

9 release left button

10 delay 64 milliseconds

11 repeat three time from Line 7 to this line.

The concrete operating process is as follows:

Step 1: firstly, opening the specific purpose programming interface 10 corresponding to the specific purpose programming software;

Step 2: selecting Button 8 of the mouse in the button function selection area 102;

Step 3: selecting “enter program” in a pull-down menu for Button 8, whereby a programming window 20 appears, at this time, there is no program in the programming area 205;

Step 4: selecting “left button” in the mouse simulating action instruction 203, whereby four lines of program instructions appear, such as Lines 7-10 described above;

Step 5: selecting “loop” instruction

Step 6: selecting “starting line” of “loop” instruction to be 7 or input 7

Step 7: selecting “ending line” of “loop” instruction to be 11 or input 11;

Step 8: selecting “insert” of “loop” instruction, whereby Line 11 described above appears in the programming area 205;

Step 9: selecting “escape”, and saving the combined operation instruction according to instructions.

The above combined operation instruction is compiled into a reduced instruction code which can be executed via Button 8 of the mouse, as follows:
2501, 2840, 2401, 2840, 8901, B903, ,E084, 8100, 2BFD,

and then the reduced instruction code is downloaded in a non-volatile memory corresponding to the mouse.

If users press Button 8 of the mouse, then the input device will read and execute the code 2501, 2840, 2401, 2840, 8901, B903, E084, 8100, 2BFD in the non-volatile memory in proper sequence. The actions are described as three continuous signals of left mouse button.

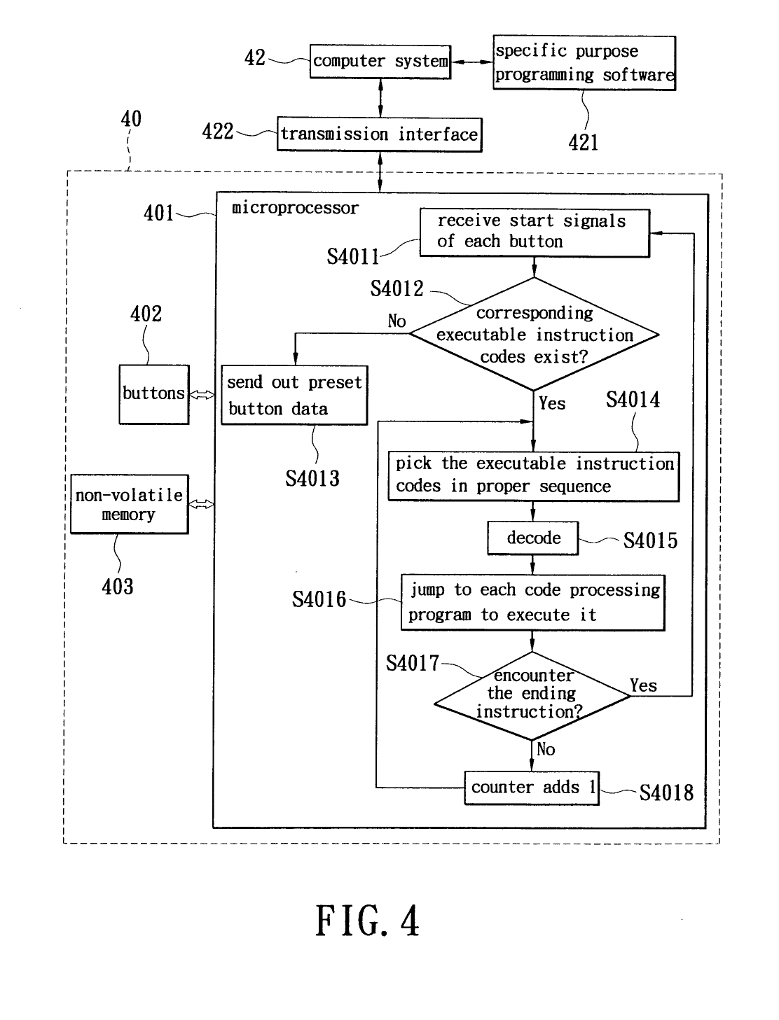

Please refer to FIG. 4 showing a block schematic view of the input device for executing an instruction code according to the present invention. The input device 40 is connected to a computer system 42 via a transmission interface 422 (for example, USB interface). The computer system 42 is installed the specific purpose programming software 421 described above therein for downloading program codes which can be executed by the input device 40 to the input device 40 via the transmission interface 422.

The input device for executing an instruction code 40 according to the present invention includes a plurality of buttons 402 (for example, Buttons 1-14 as shown in FIG. 1), each of which is set to show a continuous operation action in the computer system 42. A plurality of instruction codes which can be executed by the input device 40 are downloaded from the computer system 42 and stored in the non-volatile memory 403, and each instruction code corresponds to the continuous operation action of each button 402. A microprocessor 401 includes several firmware units such as an instruction program counter, a reduced instruction encoder, a reduced instruction execution core and so on for processing received executable program codes. To explain the work process of the microprocessor 401, the embodiment is described basing on the work flow, but the work process may be performed by the firmware units.

Firstly, at step S4011, the microprocessor 401 receives start signals of each button 402; at step S4012, the microprocessor 401 judges if the non-volatile memory 403 stores executable instruction codes corresponding to the received start signals (for example, if the start signal is 11, then the microprocessor 401 checks if the non-volatile memory 403 stores the executable instruction code corresponding to No. 11). If not, then at step S4013, the microprocessor 401 sends out preset button data (that is, original operations of the buttons); otherwise, at step S4014, the microprocessor 401 picks the executable instruction codes in proper sequence from corresponding addresses in the non-volatile memory 403, and then decodes the executable instruction codes into code processing programs at step S4015, and jump to each code processing program to execute it at step S4016, whereby to execute the executable instruction codes stored in the non-volatile memory 403.

The instruction codes which can be executed by the input device 40 are a reduced instruction codes which include an ending instruction, a plurality of basic instructions and a plurality of conditional judgment instructions. The ending instruction is used for ending the execution process of the executable instruction codes and entering a waiting state for waiting a next start signal, so the microprocessor 401 will return to step S4011 and wait for a next start signal when encountering the ending instruction at S4017. If the microprocessor 401 doesn't encounter the ending instruction, then the instruction program counter adds 1 and the microprocessor 401 picks a next executable instruction at step S4014.

The above basic instructions and conditional judgment instructions include a data transit instruction, a logical operation instruction, an arithmetic operation instruction, an unconditional jump instruction, a conditional jump instruction and an input device instruction. Each basic instruction is followed by zero-two operands which may be variables, constants, address pointers for the basic instruction. The variables include data, events and time of the input device. The address pointers for the basic instruction correspond to addresses in the non-volatile memory 403. For example, the unconditional jump instruction and the conditional jump instruction are conditional judgment instructions for performing functions of cycle and delay etc. The conditional jump instruction may, for example, include a button state conditional jump instruction. Basing on the button state conditional jump instruction, for example, users may perform a function of a particular button of the mouse as continuous and slow signals of the left mouse button, however, if another particular button of the mouse is pressed at the same time, then users may perform a function of continuous and fast signals of the left mouse button.

Additionally, the above instructions of the input device are those instructions for sending out signals from the input device. The signals from the input device include pressing and releasing signals of the buttons of the mouse, turning wheel upward and downward signals, displacement value signals, button signals of the keyboard and so on, and further include a resolution setting instruction for a displacement sensor and a plurality of switch setting instructions. The resolution setting instruction includes setting constant resolution, setting increasing resolution and setting decreasing resolution. The switch setting instructions is used for setting which instruction code need to be executed at present. Alternatively, when a plurality of instruction codes are set to be a group and a plurality of groups of instruction codes are stored, the switch setting instructions may be used for switching between different groups so as to switch from a current group to another group.

The input device described above may be a wireless input device group which includes a wireless input device (that is, a keyboard or a mouse) and a receiver. The wireless input device transmits the above start signals basing on radio frequency or infrared rays, and the receiver includes the non-volatile memory 403 and the microprocessor 401 described above.

Accordingly, basing on the present invention, for example, during running a computer game, Button “Ctrl” of a keyboard may be simulated by a mouse and defined on a self-defining button of the mouse. A self-defining button 6 of the mouse is coupled to a computer game edit software installed in a computer via a transmission interface and edited to have the function of Button “Ctrl” of the keyboard via the microprocessor. The set result is saved in a non-volatile memory. At this time, when a user presses the self-defining button 6 of the mouse, the character in the game will crouch down till the self-defining button 6 is released. Other function buttons;, such as “shift”, left translation button, right translation button and so on, may be defined on the buttons of the mouse, and other games also may self-define buttons of the mouse to have corresponding functions via the microprocessor of the mouse. Thereby, users can easily play computer games via a mouse without the help of the keyboard.

What are disclosed above are only the specification and the drawings of the preferred embodiments of the present invention and it is therefore not intended that the present invention be limited to the particular embodiments disclosed. It will be understood by those skilled in the art that various equivalent changes may be made depending on the specification and the drawings of the present invention without departing from the scope of the present invention.

What is claimed is:

1. A method for generating an instruction code which is executed by an input device, comprising the steps of:
starting a specific purpose programming software to show a specific purpose programming interface which is used for simulating to show a plurality of corresponding buttons according the input device;
selecting a corresponding button waiting for being defined and entering a programming window;
selecting any instruction for the corresponding button waiting for being defined to form a combined operation instruction in proper sequence;
compiling the combined operation instruction to form an instruction code which can be executed by the input device; and
downloading the instruction code to the input device, wherein the input device shows a continuous operation action when the corresponding button waiting for being defined is pressed.

2. The method as claimed in claim 1, wherein the instruction code which can be executed by the input device is a reduced instruction code.

3. The method as claimed in claim 1, wherein the corresponding buttons correspond to all buttons and wheels on the input device.

4. The method as claimed in claim 1, wherein the selection for the corresponding button waiting for being defined further is set to include event selections corresponding to a keyboard, a mouse, multimedia, a network, a system, inputting characters, executing software, entering program and executing programming files.

5. The method as claimed in claim 1, wherein the selection instructions provided by the programming window include a plurality of operator instructions, a time control instruction, a mouse simulating action instruction, a keyboard simulating action instruction, an actual keyboard action instruction and an actual mouse action record instruction.

6. The method as claimed in claim 1, wherein the programming window further provides a plurality of input operation instructions and a programming area.

7. An interface for generating an instruction code which is executed by the input device, comprising:
an appearance simulation area for simulating to show a plurality of corresponding buttons according to the input device;
a button function selection area, having a plurality of functions corresponding to each corresponding button;
a programming window, providing selection instructions for each corresponding button to form a combined operation instruction in proper sequence; and
a program download area, compiling the combined operation instruction to form an instruction code which can be executed by the input device and providing the instruction code for the input device to download, thereby the input device shows a continuous operation action when an corresponding button waiting for being defined is pressed.

8. The interface as claimed in claim 7, wherein the instruction code which can be executed by the input device is a reduced instruction code.

9. The interface as claimed in claim 7, wherein the corresponding buttons correspond to all buttons and wheels on the input device.

10. The interface as claimed in claim 7, wherein the functions include event selections corresponding to a keyboard, a mouse, multimedia, a network, a system, inputting characters, executing software, entering program and executing programming files.

11. The interface as claimed in claim 7, wherein the selection instructions provided by the programming window include a plurality of operator instructions, a time control instruction, a mouse simulating action instruction and a keyboard simulating action instruction.

12. The interface as claimed in claim 7, wherein the programming window further provides a plurality of input operation instructions and a programming area.

13. The interface as claimed in claim 7, wherein the selection instructions provided by the programming window include an actual keyboard action instruction and an actual mouse action record instruction.

14. The interface as claimed in claim 7, further comprising an action description area for annotating the continuous operation action corresponding to each corresponding button.

15. The interface as claimed in claim 7, further comprising a file processing area for processing of opening a new file, opening an old file, quickly opening a file, saving a file, saving as a new file, deleting a file, rename a file, inserting a file, extracting a file, reading a file, downloading a file and ending a file.

16. An input device for executing an instruction code which is connected to a computer system, comprising:
a plurality of buttons, set to show continuous operation actions in the computer system;
a non-volatile memory, storing a plurality of instruction codes downloaded from the computer system, which can be executed by the input device, wherein each instruction code corresponds to the continuous operation action of each button; and
a microprocessor receiving start signals of each button, and correspondingly encoding and executing the instruction codes stored in the non-volatile memory according to the start signals.

17. The input device as claimed in claim 16, wherein the microprocessor further judges if the non-volatile memory stores the instruction codes which can be executed by the input device, corresponding to the received start signals; if not, the microprocessor sends out preset button data; otherwise, the microprocessor picks the instruction codes which can be executed by the input device in proper sequence from corresponding addresses in the non-volatile memory.

18. The input device as claimed in claim 16, wherein the instruction codes which can be executed by the input device are a reduced instruction codes which include an ending instruction and a plurality of basic instructions.

19. The input device as claimed in claim 18, wherein the ending instruction is used for ending execution processes of the instruction codes which can be executed by the input device and entering a waiting state for waiting a next start signal.

20. The input device as claimed in claim 18, wherein the basic instructions include a data transit instruction, a logical operation instruction, an arithmetic operation instruction or an input device instruction, and each basic instruction is followed by zero-two operands which include variables, constants and address pointers for basic instructions, and the variables include data, events and time of the input device, and address pointers for the basic instructions correspond to addresses in the non-volatile memory.

21. The input device as claimed in claim 18, wherein the basic instructions include an input device instruction which is an instruction for sending out signals from the input device.

22. The input device as claimed in claim 21, wherein the input device instruction further includes a resolution setting instruction for a displacement sensor which includes setting constant resolution, setting increasing resolution and setting decreasing resolution.

23. The input device as claimed in claim 21, wherein the input device instruction further includes a plurality of switch setting instructions which are used for setting which instruction code need to be executed at present, or switching from a current group to another group when a plurality of instruction codes are set to be a group and a plurality of groups of instruction codes are stored.

24. The input device as claimed in claim 16, wherein the instruction codes which can be executed by the input device are a reduced instruction codes which include a plurality of conditional judgment instructions.

25. The input device as claimed in claim 24, wherein the conditional judgment instructions are an unconditional jump instruction or a conditional jump instruction.

26. The input device as claimed in claim 25, wherein the conditional jump instruction includes a button state conditional jump instruction.

27. The input device as claimed in claim 16, being a keyboard or a mouse, wherein the buttons correspond to all buttons and wheels on the input device.

28. The input device as claimed in claim 16, being a wireless input device group, comprising:
a wireless input device, transmitting the start signals via radio frequency or infrared rays; and
a receiver including the non-volatile memory and the microprocessor, and receiving the start signals and encoding and executing the instruction codes stored in the non-volatile memory in proper sequence.
